(19) United States
(12) Patent Application Publication
(10) Pub. No.: US 2007/0019269 A1
(43) Pub. Date: Jan. 25, 2007

(54) Optical scanning device and image forming apparatus

(76) Inventor: Akihisa Itabashi, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/453,825

(22) Filed: Jun. 16, 2006

(30) Foreign Application Priority Data
Jul. 20, 2005 (JP) 2005-210505

(51) Int. Cl. G02B 26/08

(52) U.S. Cl. 359/196

(57) ABSTRACT

An optical deflector deflects an optical beam output from a light source. An imaging optical system condenses the optical beam deflected by the optical deflector onto a surface to be scanned. The light source, the optical deflector, and the imaging optical system are accommodated in a housing. The housing includes a plurality of optical-deflector supporting units that supports the optical deflector; and an imaging-optical-system supporting unit that supports the imaging optical system. Distances from each of the optical-deflector supporting units to the imaging-optical-system supporting unit are substantially the same.

### CROSS-REFERENCE TO RELATED APPLICATIONS

The present document incorporates by reference the entire contents of Japanese priority document, 2005-210505 filed in Japan on Jul. 20, 2005.

### BACKGROUND OF THE INVENTION

1. Field of the Invention

The present invention relates to an optical scanning device and an image forming apparatus, and, more specifically to an optical scanning device and an image forming apparatus that can suppress deformation of optical elements due to heat generated by an optical deflector.

2. Description of the Related Art

Recently, in image forming apparatuses such as a digital copying machine and a laser printer, a so-called electrophotographic method is used as an image forming method. In an electrophotographic image forming apparatus, an electrostatic latent image is formed on a photoconductor by irradiating optical beams onto the photoconductor from an optical scanning device; the image is developed by a toner, and transferred onto recording paper to output images.

Particularly, in the optical scanning device, optical beams from a light source are deflected to perform scanning by a polygon mirror provided in the optical deflector, and the deflected beams of light are condensed toward the photoconductor, which is a target surface, by using a scanning image forming optical element such as an fθ lens, thereby forming an optical spot, and the photoconductor is scanned by the optical spot.

The quality of images formed by the image forming apparatus is affected by the quality of optical scanning. The quality of optical scanning depends on scanning characteristics in horizontal and vertical scanning directions of the optical scanning device, and the scanning characteristics of the optical scanning device have a large influence on the quality of the formed image.

The scanning characteristics in the horizontal scanning direction include, for example, a constant velocity in the optical scanning. When the polygon mirror (rotary polygon mirror) is used as the optical deflector, beams of light are deflected in a constant angular velocity. Accordingly, by using the scanning image forming optical system having an fθ characteristic, a constant velocity in optical scanning can be achieved.

However, it is not easy to achieve a perfect (ideal) fθ characteristic, in view of relations with other characteristics required for the scanning imaging forming optical system. Accordingly, actual optical scanning is not performed in a perfectly constant velocity, and the optical scanning is performed while being deviated from an ideal constant velocity.

The scanning characteristics in the vertical scanning direction include curve of scan lines and inclination of the scan lines. The scan line is a moving track of the optical spot on the photoconductor, which is the target surface, and ideally, it is a straight line. The curve of scan line is a phenomenon that the scan line is curved in the vertical scanning direction. The inclination of scan lines is a phenomenon that the scan lines are not orthogonal to the vertical scanning direction but inclined, and is a type of the curve of scan lines.

These types of phenomenon are caused by a machining error or a fitting error of respective optical elements and mechanical parts of the optical scanning device. When an imaging mirror is used as the scanning image forming optical system, and the deflected beams of light have an angle in the vertical scanning direction between an incident direction to the imaging mirror and a reflecting direction from the imaging mirror, generation of the curve of scan lines cannot be avoided on the theory. In addition, when the scanning image forming optical system is formed as a lens system, generation of the curve of scan lines cannot be avoided in a multi-beam scanning method where a plurality of optical spots separated in the vertical scanning direction is used for optical scanning.

In the case of an image forming apparatus in which output images are monochrome, since a write process is performed by a single optical scanning device, visible distortion does not occur in a formed image, as long as curve of scan lines and incompleteness of a constant velocity (deviation from the ideal constant velocity scanning) are suppressed to some extent. However, it is better to have such a deviation in the image reduced.

On the other hand, in the case of a color image forming apparatus that forms images of three colors of magenta, cyan, and yellow, or four colors adding black to these colors on respective photoconductors as toner images (color component images) to form a color image synthetically by superposing these color component images on each other, if a difference in positions of scan lines, or curved amount or inclination of the scan lines are different for each color component, out of color registration occurs in the formed color image. This causes degradation or abnormality in output images.

As a technique for solving the curve of scan lines and inclination of the scan lines adversely affecting the formed images, an optical scanning device that corrects the curve of scan lines and inclination of the scan lines by bending or inclining the scan lines in the vertical scanning direction, using a plurality of fulcrums of a long lens as a support point has been disclosed (for example, Japanese Patent Application Laid-open No. 2002-258189).

Furthermore, in the case of an image forming apparatus that forms an image by superposing toner images on the respective photoconductors such as the color image forming apparatus, deviation in registration in the vertical scanning direction of respective toner images occurs, due to a difference in time from formation to transfer of a latent image and a difference in spaces between the photoconductors for respective colors, due to eccentricity of the photosensitive drum or a difference in diameter, and a speed change or meander of a carrier belt that carries recording paper. The deviation in registration causes degradation in the image quality, such as out of color registration and discoloration of the formed image. Similarly, deviation in registration occurs in the optical scanning device, unless magnification in the horizontal scanning direction and write positions of the electrostatic latent image to be formed on the photoconductors are set accurately.

As a technique for solving a problem of the deviation in registration, an optical scanning device has been disclosed, which regularly detects a pattern for detecting the deviation in registration formed on the transfer belt at the time of activation of the apparatus or between jobs, corrects a position of the first line in the vertical scanning direction by adjusting the write timing for every other plane of the polygon mirror, and corrects a write position in the horizontal scanning direction by adjusting the timing from a synchronism detection signal generated at a scan starting end (for example, Japanese Patent Application Laid-open Nos. 2001-253113 and 2003-154703).

Furthermore, Japanese Patent Application Laid-open No. H9-58053 discloses an image forming apparatus that adjusts the frequency of pixel clocks by detecting scan time from the scan starting end to a scan terminating end, thereby adjusting full magnification between respective colors.

Recently, to improve scanning characteristics, a scanning image forming optical system having a special surface represented by an aspheric surface has been used. This system is constructed by using a resin material that can easily form the special surface and is low cost as a raw material.

Scanning image forming lenses such as the fθ lens representative as the scanning image forming optical system are generally formed as a rectangular lens long in the horizontal scanning direction by cutting a useless portion as a lens in the vertical scanning direction (a portion where the deflected beams of light do not enter). For the scanning image forming lens, it is necessary to increase the lens length in the horizontal scanning direction as the lens is away from the polygon mirror as the optical deflector, and hence it becomes a long lens having a length of about 100 to 250 millimeters or more.

In the scanning image forming optical system formed of the resin material, the optical characteristics are likely to change due to the influence of changes in ambient temperature and humidity. Consequently, when temperature distributions in the lens become non-uniform due to a temperature change outside, warpage occurs in the scanning image forming lens having such a long lens shape, and the scanning image forming lens becomes a bowed shape in the vertical scanning direction. The warpage of the long lens causes the curve of scan lines and scanning misregistration.

Accordingly, for example, in the color image forming apparatus, when several tens of color images are to be output continuously, since heat due to driving of the polygon mirror as the optical deflector is conducted to the scanning image forming optical system, the optical characteristics of the scanning image forming optical system change. Therefore, the curved degree of the scan lines written by the respective optical scanning device and the constant velocity gradually change, thereby causing out of color registration resulting from the curve of scan lines and scanning misregistration. As a result, hue of a color image obtained at the beginning and hue of a color image obtained at the end become quite different.

Since the warpage of the lens is caused by non-uniform temperature distributions in the lens, the problem described above can be suppressed by a configuration in which non-uniformity of the temperature distributions is suppressed in the lens.

However, the object of the techniques disclosed in the patent documents mentioned above is not to suppress the non-uniformity of the temperature distributions in the lens.

### SUMMARY OF THE INVENTION

It is an object of the present invention to at least partially solve the problems in the conventional technology.

An optical scanning device according to one aspect of the present invention includes a light source that outputs an optical beam; an optical deflector that deflects the optical beam output from the light source; an imaging optical system that condenses the optical beam deflected by the optical deflector onto a surface to be scanned; and a housing that accommodates the light source, the optical deflector, and the imaging optical system. The housing includes a plurality of optical-deflector supporting units that supports the optical deflector; and an imaging-optical-system supporting unit that supports the imaging optical system. Distances from each of the optical-deflector supporting units to the imaging-optical-system supporting unit are substantially the same.

An optical scanning device according to another aspect of the present invention includes a light source that outputs an optical beam; an optical deflector that deflects the optical beam output from the light source; an imaging optical system that condenses the optical beam deflected by the optical deflector onto a surface to be scanned; and a housing that accommodates the light source, the optical deflector, and the imaging optical system. The housing includes a plurality of optical-deflector supporting units that supports the optical deflector; and a plurality of imaging-optical-system supporting units that supports the imaging optical system. A distance from any one of the optical-deflector supporting units to a nearest optical-deflector supporting unit is substantially the same for all of the optical-deflector supporting units.

An optical scanning device according to still another aspect of the present invention includes a light source that outputs an optical beam; an optical deflector that deflects the optical beam output from the light source; a cover member that spatially shields the optical deflector; an imaging optical system that condenses the optical beam deflected by the optical deflector onto a surface to be scanned; and a housing that accommodates the light source, the optical deflector, and the imaging optical system. A material that forms the housing and a material that forms a joining surface of the optical deflector for joining the optical deflector with the housing are substantially the same.

An image forming apparatus according to still another aspect of the present invention includes an optical scanning device that includes a light source that outputs an optical beam; an optical deflector that deflects the optical beam output from the light source; an imaging optical system that condenses the optical beam deflected by the optical deflector onto a surface to be scanned; and a housing that accommodates the light source, the optical deflector, and the imaging optical system. The housing includes a plurality of optical-deflector supporting units that supports the optical deflector; and an imaging-optical-system supporting unit that supports the imaging optical system. Distances from each of the optical-deflector supporting units to the imaging-optical-system supporting unit are substantially the same.

An image forming apparatus according to still another aspect of the present invention includes an optical scanning device that includes a light source that outputs an optical beam; an optical deflector that deflects the optical beam output from the light source; an imaging optical system that condenses the optical beam deflected by the optical deflector onto a surface to be scanned; and a housing that accommodates the light source, the optical deflector, and the imaging optical system. The housing includes a plurality of optical-deflector supporting units that supports the optical deflector; and a plurality of imaging-optical-system supporting units that supports the imaging optical system. A distance from any one of the optical-deflector supporting units to a nearest optical-deflector supporting unit is substantially the same for all of the optical-deflector supporting units.

An image forming apparatus according to still another aspect of the present invention includes an optical scanning device that includes a light source that outputs an optical beam; an optical deflector that deflects the optical beam output from the light source; a cover member that spatially shields the optical deflector; an imaging optical system that condenses the optical beam deflected by the optical deflector onto a surface to be scanned; and a housing that accommodates the light source, the optical deflector, and the imaging optical system. A material that forms the housing and a material that forms a joining surface of the optical deflector for joining the optical deflector with the housing are substantially the same.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of an optical scanning device;

FIG. 2 is a perspective view of the configuration of a light source unit;

FIG. 3 is a perspective view of the configuration of an anamorphic lens support plate;

FIG. 4 is a side view of the anamorphic lens support plate in a state where an anamorphic lens is fitted to the support plate;

FIGS. 5A and 5B are perspective views of the configuration of a non-parallel plate;

FIG. 6 depicts the configuration of a detection sensor;

FIG. 7 depicts the configuration of a write control system;

FIG. 8 is an explanatory diagram of a pixel clock;

FIG. 9 depicts the configuration of a misregistration control system;

FIG. 10 is an explanatory diagram of a phase shift;

FIG. 11 is a graph showing a change of magnification with respect to temperatures in respective divided sections;

FIG. 12 depicts a toner image detection pattern;

FIG. 13 depicts an image forming apparatus;

FIGS. 14A and 14B depict an optical deflector fitted to an optical housing and a periphery thereof;

FIG. 15 depicts an optical deflector fitted to an optical housing and a periphery thereof;

FIG. 16 depicts an optical deflector fitted to an optical housing and a periphery thereof; and

FIG. 17 depicts an optical deflector to which a cover member is fitted.

### DETAILED DESCRIPTION OF THE PREFERRED EMBODIMENTS

Exemplary embodiments of the present invention will be explained in detail below with reference to the accompanying drawings.

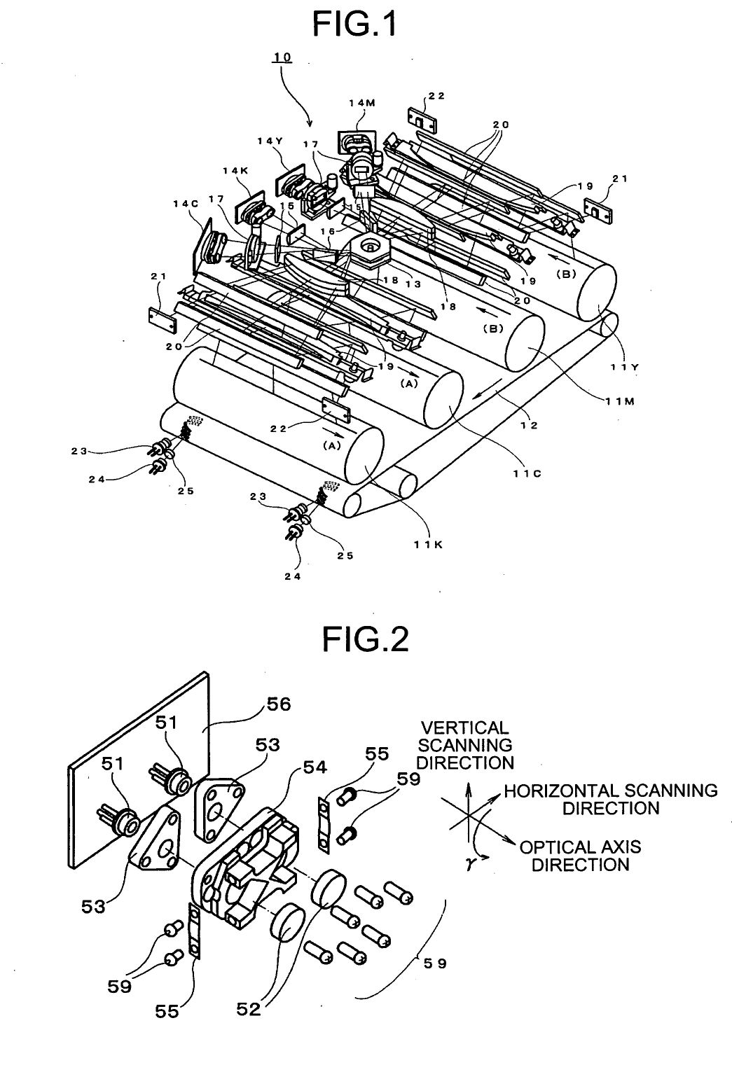

FIG. 1 is a perspective view of an optical scanning device 10 that scans four photosensitive drums. As shown in FIG. 1, the optical scanning device 10 according to the present embodiment adopts an opposed scanning method where four photosensitive drums 11Y to 11K (yellow, magenta, cyan, and black) are divided into two, and optical beams are emitted for each color from a side opposite to a single polygon mirror 13 having a two-layer structure to deflect to perform scanning, thereby forming an electrostatic latent image on photosensitive drums 11 in opposite directions.

The photosensitive drums 11Y to 11K, which are the objects to be deflected to perform scanning, are arranged on a transfer belt 12 (a carrier belt) at equal intervals along a moving direction of recording paper, which is a transfer medium. A color image is formed by sequentially transferring different color toner images onto the transfer medium, and superposing the respective color toner images.

In the optical scanning device 10 according to the present embodiment, the rotation direction of the polygon mirror 13 is counterclockwise. Since the rotation direction of the polygon mirror 13 is not changed, the scanning direction thereof becomes opposite on the opposite sides (see arrows A and B in FIG. 1). Therefore, an image is written such that a write start position on one side and a write end position on other side are coincided with each other.

The optical scanning device 10 according to the present embodiment includes the polygon mirror 13, light source units 14Y to 14K, cylindrical lenses 15, incident mirrors 16, non-parallel plate holding units 17, fθ lenses 18, anamorphic lenses 19, folding mirrors 20, synchronization detection sensors 21, termination detection sensors 22, LED devices 23, photosensors 24, and condenser lenses 25. These respective parts constituting the optical scanning device 10 are mounted on an optical housing 100 (not shown).

The polygon mirror 13 is formed of a regular polygonal prism for performing deflected scan, and according to the present embodiment, has a two-layer structure where two regular polygonal mirrors are overlapped on each other. According to the present embodiment, a groove having a slightly smaller diameter than that of an inscribed circle of the polygon mirror 13 is provided in an intermediate part of the mirror, which is not used for deflection, so that a windage loss can be reduced. The phases of the upper and lower mirrors are the same, and the thickness of one layer is about 2 millimeters.

The polygon mirror 13 is formed as a part of an optical deflector (polygon scanner) 101 (described later).

The light source units 14Y to 14K are provided for each photosensitive drum 11 of the respective colors, and outputs optical beams for forming an electrostatic latent image on the photosensitive drum 11. According to the present embodiment, to scan two lines simultaneously, scanning is performed with each scan line pitch being shifted one by one in a scanning direction corresponding to a recording density.

FIG. 2 is a perspective view of the light source unit 14. The respective light source units 14Y to 14K have the same configuration.

In the light source unit 14, two semiconductor lasers (laser diodes) 51 and two coupling lens 52 are arranged symmetrically in a horizontal scanning direction with respect to an emission axis. The semiconductor laser 51 is fitted to a base member, with the outer circumference of a package press-fitted by a rear side of a base member 53, and the semiconductor laser 51 is enchased in the base member 53. The base member 53 is held on a rear surface of a holder member 54 by a screw 59 penetrated from the front of the holder member 54. The coupling lens 52 is screwed and fixed to a V-groove formed on the surface of the holder member 54 by a holding plate spring 55.

The respective components of the light source unit 14 are arranged such that a luminescent point of the semiconductor laser 51 is on an optical axis of the coupling lens 52 and emitted light from the coupling lens 52 becomes parallel beams of light.

The optical axis of the respective emitted light of the semiconductor lasers 51 is inclined with respect to the emission axis so as to cross each other. In the light source unit 14 according to the present embodiment, the inclination is set such that the crossing position comes close to a deflection reflecting surface of the polygon mirror 13.

A printed board 56, on which a driving circuit is formed, is screwed and fixed to a seat provided in a standing condition on the holder member 54. Furthermore, the light source unit 14 is integrally formed by inserting a guided terminal of the respective semiconductor lasers 51 into a through hole in the printed board 56 and soldering the guided terminal thereto.

The light source unit 14 is fixed by being screwed to the wall of the optical housing 100. At this time, by adjusting the inclination amount γ of the light source unit 14, a beam spot interval can be coincided with a scan line pitch P corresponding to a recording density.

In the optical scanning device 10 according to the present embodiment, the light source units 14Y and 14K, and the light source units 14M and 14C are arranged, with the height of an emission position of optical beams (position in the vertical scanning direction) being different by 6 millimeters (14Y and 14K are arranged at lower positions). This is because the optical beams can enter into the respective layers of the polygon mirror 13 having two layers.

The cylindrical lens 15 is respectively provided on an optical path between the respective light source units 14 and the polygon mirror 13, and one surface has a planar shape, and other surface has a shape having a common curvature in the vertical scanning direction. The cylindrical lenses 15 are arranged such that an optical path length to the deflection reflecting surface of the polygon mirror 13 becomes equal.

The cylindrical lenses 15 condense the respective optical beams output from the respective light source units 14 so as to be linear in the horizontal scanning direction on the deflection surface. The cylindrical lens 15 forms a cross-scan error compensation optical system, by forming a conjugate relationship between the deflection point and on the photosensitive drum 11 in the vertical scanning direction, combined with an imaging optical system formed of the fθ lens 18 and the anamorphic lens 19.

The incident mirror 16 is respectively provided on the optical path of the optical beams output from the light source units 14Y and 14K, between the cylindrical lens 15 and the polygon mirror 13, and reflects the optical beams from the light source units 14Y and 14K such that the horizontal scanning direction thereof is adjacent to the horizontal scanning direction of the optical beams output from the light source units 14C and 14M and directly heading toward the polygon mirror 13.

The non-parallel plate holding unit 17 is a member (device) that holds a non-parallel plate, which is a glass substrate, with any one surface being slightly inclined in the horizontal scanning direction or in the vertical scanning direction, and functions as an optical axis changing unit. The non-parallel plate holding unit 17 is arranged on the optical path of the light source unit 14 excluding the light source unit 14 corresponding to a reference color, and stabilizes the respective scanning positions by controlling the rotation of the non-parallel plate around the optical axis. In the optical scanning device 10 according to the present embodiment, the non-parallel plate holding unit 17 is provided on the optical path of the light source units 14Y to 14C excluding the light source unit 14K.

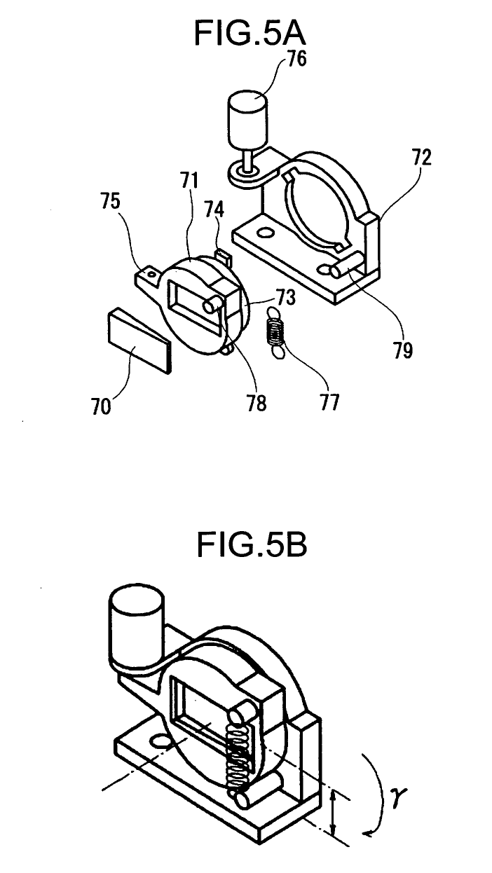

FIGS. 5A and 5B are perspective views of the non-parallel plate holding unit 17. The respective non-parallel plate holding units 17 provided on each optical path of the respective light source units have the same configuration.

A non-parallel plate 70 is fixed to a central frame of a cylindrical holder member 71. The holder member 71 is supported in an unfixed manner by a support member 72 by inserting a guard 74 formed on the holder member 71 into a notch in a bearing of the support member 72. More specifically, after the guard 74 is coincided with the notch and inserted therein, when the holder member 71 is returned to a horizontal state, the guard 74 is hooked. Therefore, the holder member 71 sticks to the support member 72, and is rotatably held by the support member 72 based on a fitting unit 73 of the holder member 71.

A lever 75 is formed at one end of the holder member 71. The lever 75 is screwed with a screw formed at a shaft end of a stepping motor 76, which is fixed to the support member 72, so that the holder member 71, in other words, the non-parallel plate 70 can be rotated with a vertical motion of the stepping motor 76. To eliminate a backlash at this time, a spring 77 is put between a pin 78 of the holder member 71 and a pin 79 of the support member 72, thereby applying a tensile force.

The bottom surface of the support member 72 is screwed to the optical housing 100. The height of the holder member 71 and the height of the light source unit 11 are respectively set such that the center of rotation of the holder member 71 coincides with the emission axis of the light source unit 11, and the emission axis of the optical beams can be slightly inclined by rotating the holder member 71.

When it is assumed that a rotation angle of the non-parallel plate 70 (holder member 71) is “γ”, a vertical angle of the non-parallel plate 70 is “ε” (about 2 degrees according to the present embodiment), a focal length of the coupling lens 52 of the light source unit 14 is “fc”, and a vertical scanning magnification of the entire optical system is “ζ”, a variation “Δy” of a vertical scanning position on the photosensitive drum can be given by
Δy=ζ·fc·(n−1)ε·sin γ (1)
where “n” in the above numerical expression is provided by a refractive index of the non-parallel plate. Therefore, in a range of a minute angle of rotation, the variation “Δy” of the vertical scanning position on the photosensitive drum can be changed in proportion to the angle of rotation of the non-parallel plate 70.

The fθ lens 18 is formed of two resin lenses provided opposite to each other near the polygon mirror 13, and has a non-circular arc lens surface. The optical beams reflected and deflected by the polygon mirror 13 scan on the photosensitive drum 11 at a constant velocity. In the optical scanning device 10 according to the present embodiment, the fθ lens 18 is formed in a two-layer integral configuration or in a two-layer bonded configuration. The fθ lens 18 constitutes the imaging optical system together with the anamorphic lens 19 provided for each optical beam.

The anamorphic lens 19 is a resin lens provided on the respective optical paths between the fθ lens 18 and the photosensitive drums 11, and constitutes the imaging optical system together with the fθ lens 18.

Since the anamorphic lens 19 is long and has a low rigidity, it deforms (warps) only by a slight stress applied. Furthermore, the anamorphic lens 19 also deforms due to a difference in thermal expansion due to temperature distributions in a vertical direction that accompanies a change in an ambient temperature.

Therefore, in the optical scanning device 10 according to the present embodiment, the anamorphic lens 19 is bonded and fixed to an anamorphic lens support plate, so as to stably maintain the shape, and not to deform the anamorphic lens 19 even when a local stress is applied at the time of adjustment (adjustment of curve of scan lines) described later.

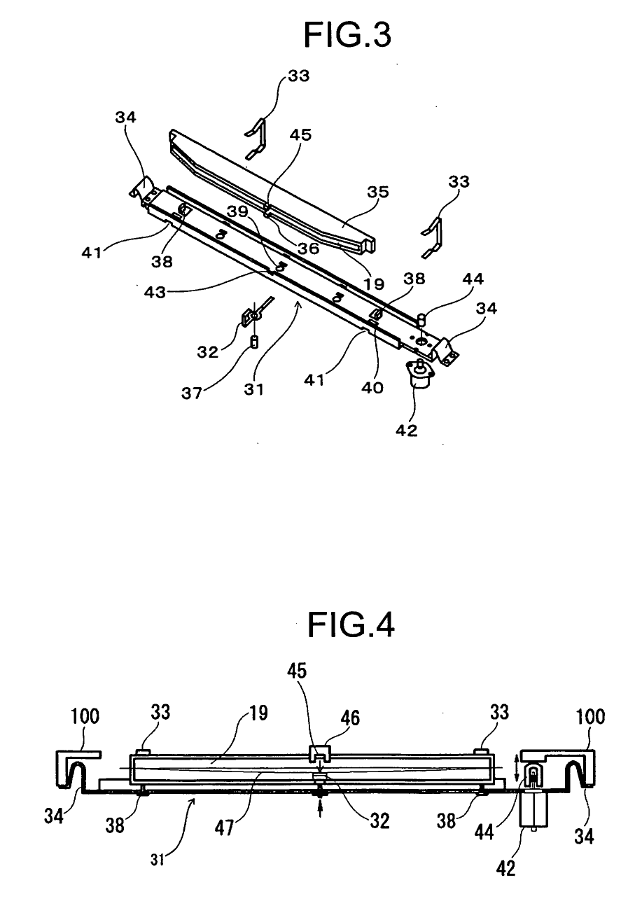

The configuration of the anamorphic lens 19 and the anamorphic lens support plate 31 (hereinafter, “support plate 31”) is shown in FIG. 3. FIG. 4 depicts a state where the anamorphic lens 19 is fitted to the support plate 31, as viewed from the side.

A rib 35 is formed on the anamorphic lens 19 so as to surround the lens. A lower protrusion 36 and an upper protrusion 45 for positioning are formed in the center of the anamorphic lens 19. The support plate 31 is made of a sheet metal in an approximate U-shape.

When the anamorphic lens 19 is bonded and fixed to the support plate 31, the lower protrusion 36 of the anamorphic lens 19 is engaged with a notch 43, and a lower surface of the rib 35 of the anamorphic lens 19 is bumped against bent portions 38 to position the anamorphic lens 19. At the opposite ends of the anamorphic lens 19, a U-shaped plate spring 33 is respectively fitted from the upper surface of the rib 35, to hold the opposite ends. At this time, one end of the U-shaped plate spring 33 is pulled from a lower opening 40 to the inside, and inserted into a side opening 41 and fixed.

A screw hole 39 is provided at a center of the support plate 31, and an adjusting screw 37 is screwed in the screw hole 39. At this time, a plate spring 32 is fitted from below the support plate 31, hooked by the inside of the lower surface of the rib 35 and fixed, so that the point of the adjusting screw 37 reliably abuts against the lower surface of the rib 35.

The support plate 31 mounted with the anamorphic lens 19 is positioned by fitting the upper protrusion 45 of the anamorphic lens 19 to a depression 46 (FIG. 4) provided on the optical housing 100 side. The support plate 31 is fitted to the optical housing 100 so as to be energized upward in the figure in a support-plate spring 34 provided at the opposite ends of the support plate 31 (see FIG. 4).

A stepping motor 42 is fixed at one end of the support plate 31, penetrating an opening formed in the support plate 31. A feed screw is formed at a shaft end of the stepping motor 42, and screwed in a screw hole of a movable cylinder 44.

According to the present embodiment, since the end of the movable cylinder 44 movable by the stepping motor 42 is bumped against the optical housing 100, displacement of the anamorphic lens 19 in a height direction (vertical scanning direction) is made possible by a rotation of the stepping motor 42. Accordingly, rotation of the anamorphic lens 19 can be adjusted within a plane orthogonal to the optical axis by using a fitting portion of the upper protrusion 45 as a fulcrum, following the reciprocal rotation of the stepping motor 42. With this configuration, since a generatrix 47 of the anamorphic lens 19 in the vertical scanning direction is inclined, scan lines as an imaging position of the anamorphic lens 19 can be inclined.

As shown in FIG. 4, the anamorphic lens 19 is supported at the opposite ends by the bent portion 38, and at the center thereof by the adjusting screw 37. When a protrusion amount of the adjusting screw 37 is smaller than the height of the bent portion 38, the generatrix 47 of the anamorphic lens 19 warps in a shape protruding downward. On the contrary, if the protrusion amount of the adjusting screw 37 exceeds the height of the bent portion 38, the generatrix 47 of the anamorphic lens 19 warps in a shape protruding upward. Therefore, the curve of scan lines can be corrected by adjusting the adjusting screw 37 so that the generatrix 47 (focal line) of the anamorphic lens 19 warps in the vertical scanning direction.

The adjusting screw 37 can be arranged at a plurality of positions along the horizontal scanning direction, and if the adjusting screw 37 is arranged at three positions, for example, at the central portion and at the middle between the central portion and the bent portions 38, M-type and W-type bendings can be also corrected.

In the optical scanning device 10 according to the present embodiment, an adjusting mechanism (scan line adjusting mechanism by the adjusting screw 37) is arranged in all anamorphic lenses including the one, through which the optical beams corresponding to the light source unit 14K as a reference pass. Furthermore, at the time of production and shipment, the direction and the amount of the curve of scan lines are equalized with those of the curve of scan lines as a reference, and the above adjustment can be performed, while this state is maintained.

The folding mirror 20 guides the optical beams deflected to scan by the polygon mirror 13 to the respective photosensitive drums 11Y to 11K. A plurality of folding mirrors 20 are arranged such that the respective optical path lengths from the polygon mirror 13 to the photosensitive drums 11Y to 11K coincide with each other, and the incident position and the incident angle with respect to the respective photosensitive drums 11 are equalized. Three folding mirrors 20 are arranged for each optical path in the optical scanning device 10 according to the present embodiment.

The synchronization detection sensor 21 formed of a substrate mounted with the photosensor (photodiode) is arranged on a scan starting side (starting end side of arrows A and B in FIG. 1) of an image recording area. The termination detection sensor 22 formed of the substrate mounted with the photosensor is arranged on a scan terminating side (terminating end side of arrows A and B) of the image recording area.

The synchronization detection sensor 21 detects the starting end side of the optical beams deflected to scan, and adjusts the write start timing of the respective optical beams based on the detection signal. The termination detection sensor 22 detects the terminating end side of the optical beams deflected to scan.

A change in the scanning speed can be detected by measuring a time difference between the detection signals of the synchronization detection sensor 21 and the termination detection sensor 22. Accordingly, by resetting a reference frequency of the pixel clock for modulating the respective semiconductor lasers 51 in the respective light source units 14 by inverse multiplication, the full magnification of images corresponding to respective colors can be maintained stably.

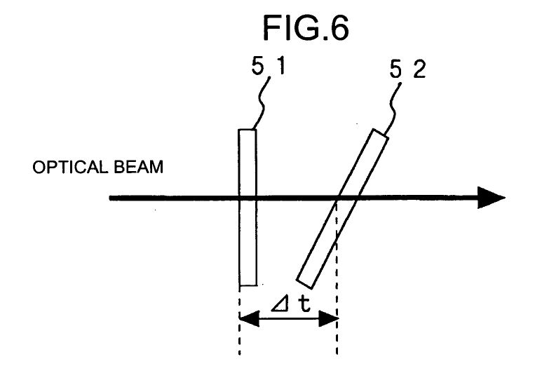

The detection sensors are formed of, as shown in FIG. 6, a photodiode 61 perpendicular to the horizontal scanning direction and a photodiode 62 nonparallel to the photodiode 61. Therefore, a deviation Δγ of the optical beams at the vertical scanning position can be detected by measuring a time difference Δt from the photodiode 61 to the photodiode 62.

The deviation Δγ of the optical beams at the vertical scanning position is expressed by Equation (2) by using an angle of inclination γ of the photodiode 62 and the scanning speed V of the optical beams.
Δy=(V/tan γ)·Δt (2)

In the optical scanning device 10 according to the present embodiment, an irradiation position is corrected so that registration in the vertical scanning direction of the images corresponding to respective colors is not shifted, by controlling the non-parallel plate holding unit 17 as the optical axis changing unit, so that the time difference Δt becomes always constant.

The LED device 23, the photosensor 24, and the condenser lens 25 detect a misregistration of the toner image by reading a detection pattern of the toner image formed on the transfer belt 12. The misregistration detection will be explained later.

The optical beams output from the light source unit 11M are irradiated onto the upper layer of the polygon mirror 13 via the non-parallel plate holding unit 17 and the cylindrical lens 15. The optical beams are deflected by a deflecting scanning surface of the upper layer of the polygon mirror 13, pass through the upper layer of the fθ lens 18, and are led to the photosensitive drum 11M by the anamorphic lens 19 and the folding mirror 20, to form an electrostatic latent image of a magenta component on the photosensitive drum 1M.

The optical beams output from the light source unit 11Y pass through the non-parallel plate holding unit 17 and the cylindrical lens 15, are reflected by the incident mirror 16, and are irradiated onto the lower layer of the polygon mirror 13. The optical beams are deflected by the deflecting scanning surface of the lower layer of the polygon mirror 13, pass through the lower layer of the fθ lens 18, and are led to the photosensitive drum 11Y by the anamorphic lens 19 and the folding mirror 20, to form an electrostatic latent image of a yellow component on the photosensitive drum 11Y.

The optical beams output from the light source unit 11C arranged opposite to the light source units 11M and 11Y are irradiated onto the upper layer of the polygon mirror 13 via the non-parallel plate holding unit 17 and the cylindrical lens 15. The optical beams are deflected by the deflecting scanning surface of the upper layer of the polygon mirror 13, pass through the upper layer of the fθ lens 18, and are led to the photosensitive drum 11C by the anamorphic lens 19 and the folding mirror 20, to form an electrostatic latent image of a cyan component on the photosensitive drum 11C. The optical beams output from the light source unit 11K pass through the cylindrical lens 15, are reflected by the incident mirror 16, and are irradiated onto the lower layer of the polygon mirror 13. The optical beams are deflected by the deflecting scanning surface of the lower layer of the polygon mirror 13, pass through the lower layer of the fθ lens 18, and are led to the photosensitive drum 11K by the anamorphic lens 19 and the folding mirror 20, to form an electrostatic latent image of a black component on the photosensitive drum 11K.

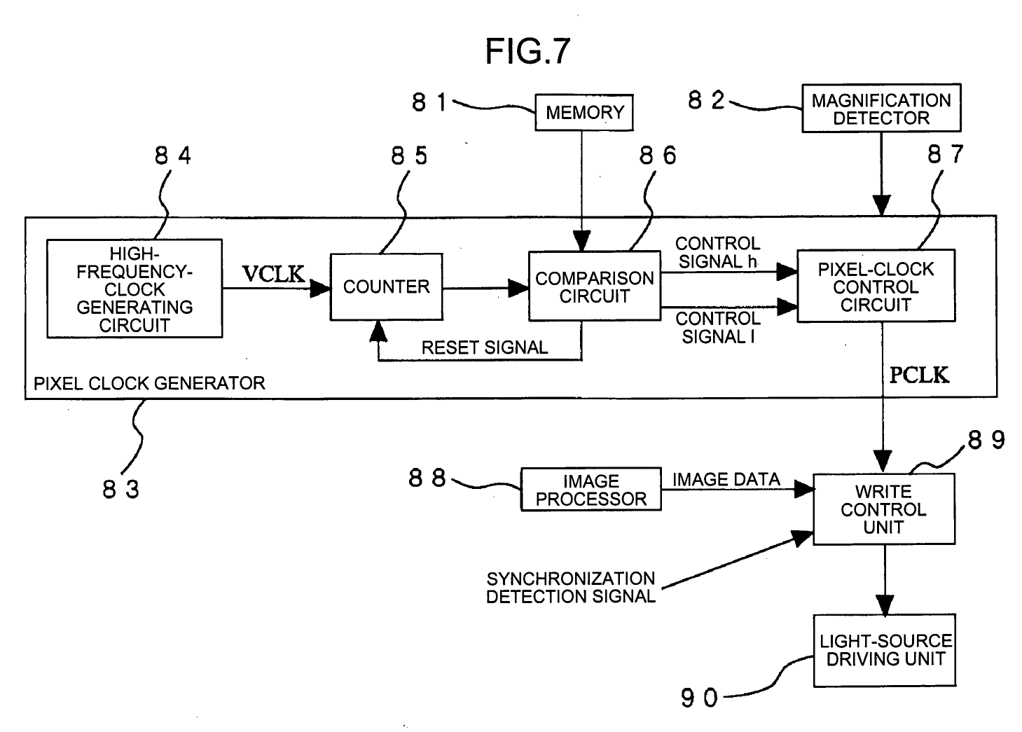

FIG. 7 depicts the configuration of a write control system according to the present embodiment. A counter 85 counts a high frequency clock VCLK generated by a high-frequency-clock generating circuit 84. A comparison circuit 86 compares the count value, a set value L preset based on a duty ratio, and phase data H given from outside (a memory 81) as a transition timing of the pixel clock and instructing a phase shift amount with each other. As a result of the comparison, when the count value and the set value L coincide with each other, the comparison circuit 86 outputs a control signal 1 instructing a fall of a pixel clock PCLK to a pixel-clock control circuit 87. When the count value and the phase data coincide with each other, the comparison circuit 86 outputs a control signal h instructing a rise of the pixel clock PCLK to the pixel-clock control circuit 87.

The comparison circuit 86 outputs a reset signal to the counter 85 simultaneously with the output of the control signal h. Since the counter 85 resets counting and recounts from zero upon reception of the reset signal, a continuous pulse string can be formed.

A pixel clock generator 83 generates the pixel clock PCLK, with the pulse cycle being sequentially changed, by providing the phase data H for every clock.

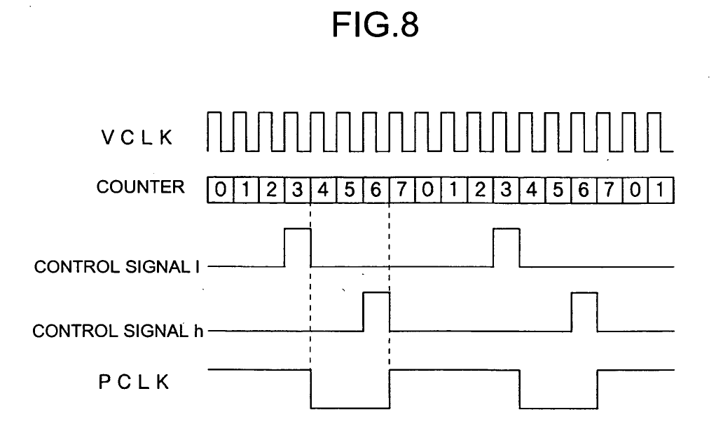

In the pixel clock generator 83 according to the present embodiment, the pixel clock PCLK is ⅛ frequency of the high frequency clock VCLK, so that the phase can be changed by a resolution of ⅛ clock. FIG. 8 depicts a clock with the phase being delayed by ⅛ clock. When it is assumed that the duty ratio is 50%, the set value L=3 is provided. The counter 85 starts counting, to allow the pixel clock PCLK to fall at count 4. If the phase is delayed by ⅛ clock, the phase data H=5 is provided, and the pixel clock PCLK is made to rise at count 7. Since the counter is reset at the same time, the pixel clock PCLK is made to fall again at count 4. This cycle is repeated. That is, the adjacent pulse cycle is shortened by ⅛ clock.

The generated pixel clock PCLK is provided to a write control unit 89. The write control unit 89 generates modulation data by allocating image data read by an image processor 88 to each pixel, based on the provided pixel clock PCLK, and transmits the modulation data to a light-source driving unit 90 that controls the drive of the respective light source units 14Y to 14K. The light-source driving unit 90 drives the respective light source units 14Y to 14K based on the modulation data.

By arranging the pixels to be phase-shifted at a predetermined interval, a distortion of partial magnification error along the scanning direction can be corrected.

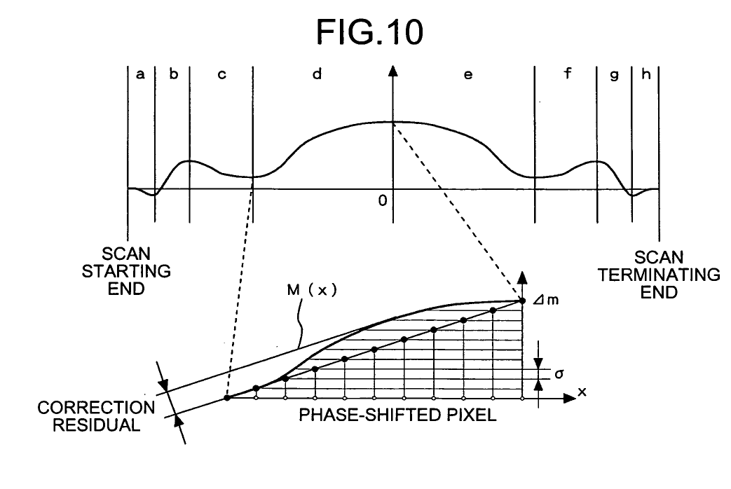

In the write control system according to the present embodiment, as shown in FIG. 10, the horizontal scanning area is divided into a plurality of sections (a to h), and an interval and a shift amount of the pixel to be shifted are set as shown below for each divided sections, and provided as the phase data.

When it is assumed that a magnification change with respect to a horizontal scanning position x is L(x), a change M(x) in misregistration of beam spot is expressed by an integral value of L(x). That is, “M(x)=**L(x)dx”. It is assumed here that the change is corrected so that the misregistration of beam spot becomes zero at a starting point of the divided sections (scan starting end) and a terminating point thereof (scan terminating end). When it is assumed that a deviation of a width of the divided section that accompanies a change in magnification in an optional divided section is Δm, a resolution of a phase shift is σ (constant), and the number of pixels in the divided section is N, an interval D of pixels to be phase-shifted is expressed by
D≈N/(Δ/σ) (3)

Consequently, the phase is shifted by C for each of D pixels. According to the present embodiment, σ becomes ⅛ pixels. In this case, a remainder of misregistration of beam spot becomes the largest at an intermediate position of the divided sections; however, the respective divided positions and the number of sections to be divided need only to be determined so that the remainder is within an allowable range.

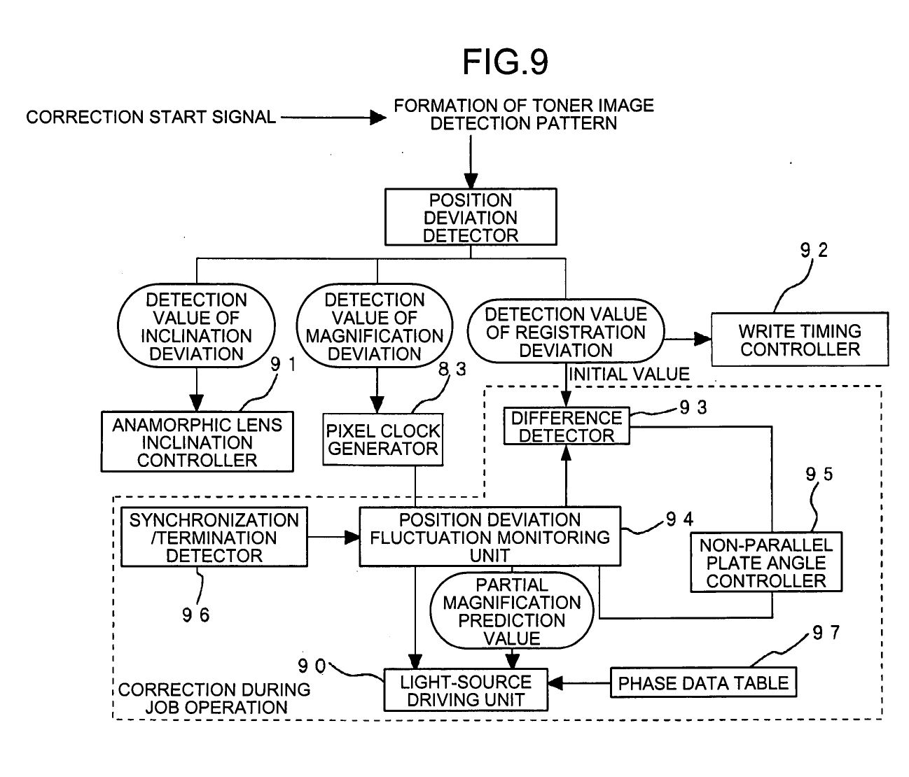

FIG. 9 depicts the configuration of a misregistration control system according to the present embodiment. Generally, it is detected how much the horizontal scanning magnification, the vertical scanning magnification, and the inclination of scan lines deviate from the reference, by reading the detection pattern of the toner image formed on the transfer belt 12, and correction control is performed based on the detection result.

The correction control is performed at the timing, for example, at the time of activation of the apparatus or between jobs. When the number of prints in one job is large, the job operation is interrupted to perform the correction control, to suppress a deviation due to a temperature change during the job operation.

Read of the detection pattern of the toner image formed on the transfer belt 12 is performed by a detecting unit formed of the illuminating LED device 23, the photosensor 24 that receives the reflected light, and a pair of condenser lenses 25. In the optical scanning device 10 according to the present embodiment, the detecting unit is arranged at two positions at the opposite ends in the horizontal scanning direction, as shown in FIG. 1.

As shown in FIG. 12, a line pattern group referred to as a Chevron patch in which the black, cyan, magenta, and yellow toner images are arranged in parallel at a predetermined pitch, inclined by about 45 degrees from the horizontal scanning direction, is used as the detection pattern of the toner image. The detection pattern is read along the movement of the transfer belt 12, thereby to detect a detection time difference tyk, tmk, and tck between black as a reference color and respective colors, and a detection time difference tk, tc, tm, and ty of a set of line patterns having a different angle of inclination. Registration in the vertical scanning direction of respective colors is obtained from a difference between the detected values of tyk, tmk, and tck and theoretical values thereof. A deviation of registration in the horizontal scanning direction of respective colors of the main scanning resists of the respective colors is obtained from a difference between the detected values tk, tc, tm, and ty and theoretical values thereof.

An inclination difference of the scan lines is obtained from a difference in registration in the vertical scanning direction at the opposite ends. The inclination difference is corrected by adjusting the inclination of the anamorphic lens 19 by an anamorphic lens inclination controller 91.

The registration in the vertical scanning direction is obtained from a mean value of respective detected values, and corrected by adjusting write start timing in the vertical scanning direction by a write timing controller 92 for every other plane of the polygon mirror 13, that is, in a unit of one scan line pitch P.

Furthermore, it is necessary to adjust a deviation in registration at a precision equal to or less than one scan line pitch P, as the required quality of the color images is increasing recently. Therefore, the non-parallel plate holding unit 17, which is the optical axis changing unit, is used to finely adjust the irradiation position, so that even a remainder equal to or less than one scan line pitch P, which cannot be corrected by the write start timing, of the deviations in registration in the vertical scanning direction detected by the toner image, can be corrected, and a reference value (initial value) of the irradiation position is set.

On the other hand, the photodiodes 61 and 62 are used between pages, to perform feedback-correction for a difference from the set reference value based on measurement values accumulated during recording images, thereby maintaining the reference value stably until the next regular correction time. The reference value is not necessarily a constant value, and for example, a value periodically changing corresponding to speed fluctuations of the transfer belt 12 can be used.

The horizontal scanning magnification is obtained from a difference in registration in the horizontal scanning direction at the opposite ends. The full width of the image and the write start position are equalized by adjusting the reference frequency of the pixel clock for modulating the semiconductor laser 51 of the respective light source unit 14 and the timing from the synchronization detection signal. A magnification change between pages is always monitored, and the reference frequency is corrected so that even if there is a temperature change, the full width does not change, based on the detection time of a synchronization detection signal and a termination detection signal detected by a synchronization/termination detector 96. Furthermore, phase data weighted by predicting a magnification change for each divided section occurring with a temperature change is pre-read from a data table corresponding to a variable amount of the full magnification, to make the magnification uniform over the whole area in the horizontal scanning direction, so that a distortion in magnification does not occur even at an intermediate image height.

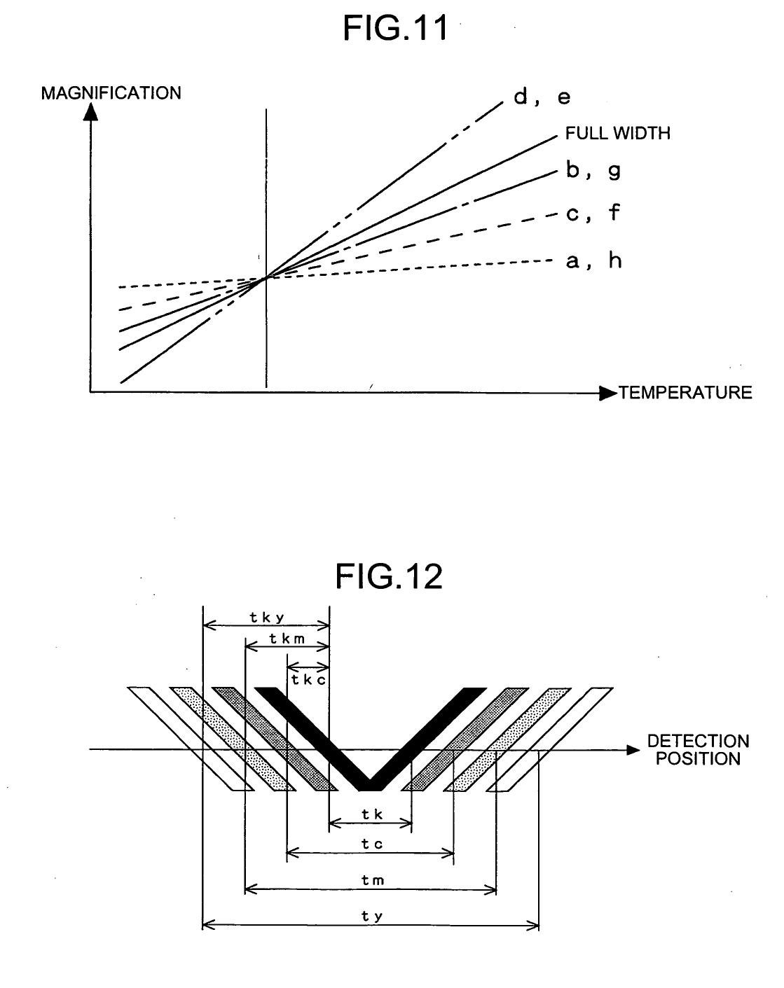

FIG. 11 depicts a change of magnification with respect to the temperature in the respective divided sections a to h. Since the magnification in the respective divided sections changes in proportion to a change in the full magnification, it can be distributed to a magnification change in the respective divided sections based on a measurement value of the full magnification.

According to the present embodiment, since fluctuations in the job are monitored, and correction is executed even between pages, in addition to the regular correction by means of detection of the toner image detection pattern, superposition accuracy of respective color images can be maintained, without interrupting the print operation during job operation.

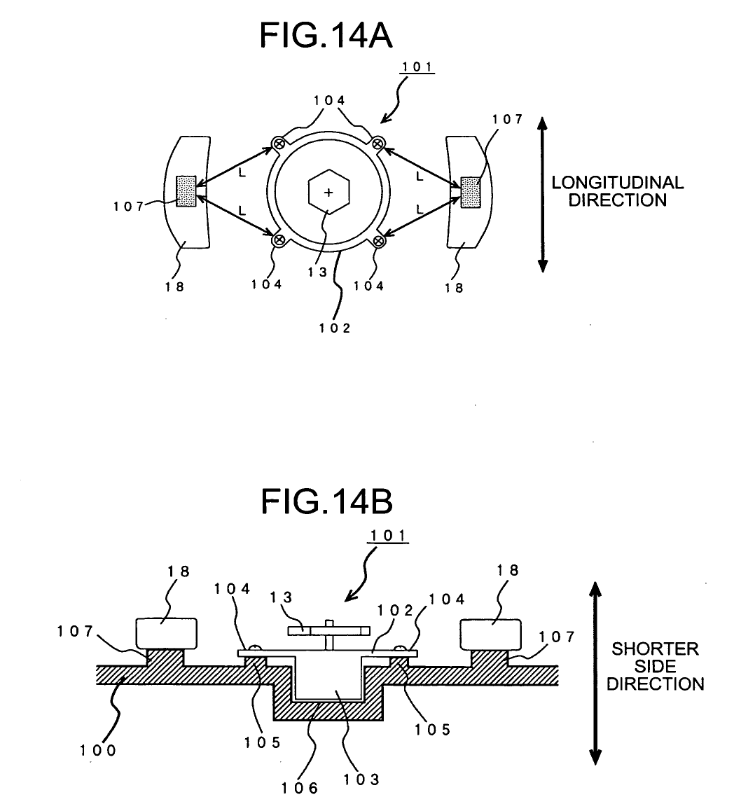

FIGS. 14A and 14B depict an optical deflector 101 fitted to the optical housing 100 and the vicinity thereof. FIG. 14A depicts a state as viewed from the upper side (from a deflecting and scanning cross section), and FIG. 14B depicts a state as viewed from a vertical scanning cross section.

The optical deflector 101 is formed by integrally fitting the polygon mirror 13 and a polygon motor to a substrate 102. The substrate 102 has a circular shape, and the polygon mirror 13 is arranged at the center on the upper surface thereof. Four fixing units 104, which are joining surfaces for fixedly joining the optical deflector 101 to the optical housing 100, are formed on the circumference of the substrate 102. The fixing units 104 are formed by changing a partial shape of the substrate 102, and integrally formed with the substrate 102. A cylindrical motor case 103 for holding the polygon motor that rotates the polygon mirror 13 is provided on the lower surface of the substrate 102.

While the substrate 102 is circular according to the present embodiment, the shape is not limited thereto, and for example, the substrate 102 can be quadrangular.

Four optical deflector positioning bases 105 for positioning the optical deflector 101, and a circular opening 106 are provided in the optical housing 100. The optical deflector positioning bases 105 are provided corresponding to the respective fixing units 104 of the optical deflector 101.

The optical deflector is fitted to the optical housing 100 by fitting the motor case 103 to the circular opening 106, and placing the fixing units 104 of the optical deflector 101 coincided with the optical deflector positioning bases 105 and screwed together.

The fθ lenses 18 as one member of the imaging optical system are arranged opposite to each other, with the optical deflector 101 put therebetween, near the optical deflector 101. At this time, the fθ lenses 18 are arranged such that the optical deflector 101 is put at a midpoint between the fθ lenses 18 facing each other. The central part (the middle part) of the lower surface of the fθ lens 18 is fixed by bonding with an ultraviolet-hardening adhesive to an fθ lens installation unit 107 having a certain width provided in the optical housing 100.

When the polygon motor is operated for rotating the polygon mirror 13, the polygon motor generates heat. The generated heat is conducted to the scanning optical system such as the fθ lenses 18 via the optical housing 100 as a floor or the ambient air. However, if the heat is conducted to the scanning optical system with a deviation, it causes a temperature deviation in the optical system.

When the temperature deviation occurs, for example, deviation occurs also in the optical characteristics, such as a magnification error in the main scanning direction. As described above, the magnification error is corrected by detecting passage timing of the optical beams by the synchronization detection sensor 21 and the termination detection sensor 22 provided at the opposite ends in the horizontal scanning direction, to obtain a variation from changes in scan time. The magnification error in the scanning range occurring due to a partial difference in the variation cannot be corrected completely, and scanning misregistration occurs as a result.

According to the present embodiment, as shown in FIGS. 14A and 14B, the optical deflector 101 is arranged such that respective distances L from the fixing units 104 and the optical deflector positioning bases 105, which connect the optical deflector 101 to the optical housing 100, to the nearest fθ lens positioning base 107 are substantially the same.

By having such a configuration, the interval between the fθ lenses 18 and the optical deflector 101 is symmetrical in a longitudinal direction, and the heat generated due to transmission from the optical deflector 101 through the optical housing 100 as the floor is conducted symmetrically in the longitudinal direction of the lens. Therefore, a temperature deviation generated in the fθ lenses 18 can be reduced, and the variation in the optical characteristics can be made symmetrical in the longitudinal direction, thereby enabling reduction of the deviation.

Therefore, occurrence of the curve of scan lines and scanning misregistration can be suppressed, thereby achieving accurate image formation. Furthermore, since an execution frequency of a series of internal correction processes can be reduced, productivity can be improved by reduction of correction during the job operation, and consumption of the toner used for the detection patterns can be also reduced.

In the optical scanning device 10 according to the present embodiment, four fixing positions (the fixing units 104 and the optical deflector positioning bases 105) are provided in the optical deflector 101, however, the number thereof is not limited thereto. The number of the fixing positions can be other than four, as long as satisfying a configuration condition such that the respective distances L from the fixing positions to the nearest fθ lens positioning base 107 are substantially the same.

Table 1 shows a result of a temperature change measurement test in which temperature changes at a plurality of positions in a longitudinal direction (the horizontal scanning direction) and a shorter side direction (the vertical scanning direction) of the fθ lenses 18 and the anamorphic lenses 19 are measured, when the polygon mirror 13 in the optical deflector 101 is driven for 2 hours in the optical scanning devices 10 having a different arrangement and configuration of the optical deflector.

TABLE 1

| | Device | | | | | |
|---|---|---|---|---|---|---|
| | (1) | (2) | (3) | (4) | (5) | (6) |
| Temperature deviation in | 1.2 | 2.2 | 1.1 | 1.2 | 5.0 | 0.8 |
| longitudinal direction | | | | | | |
| Temperature deviation in | 2.7 | 2.8 | 2.9 | 1.0 | 1.0 | 2.7 |
| the shorter side direction | | | | | | |
| | | | | | | (Unit: ° C.) |

The respective physical properties (parameters) in the measurement test are as follows.

Number of revolution of the polygon scanner: 36 krpm

Thermal conductivity of the fθ lens: k1=0.3(w/m·k)

Thermal conductivity of the anamorphic lens:
k2=0.3(w/m·k)

Thermal conductivity of the optical housing: k3=30(w/m·k)

Thermal conductivity of the polygon scanner case:
k4=260(w/m·k)

In the temperature change measurement test, since the anamorphic lens 19 is away from the optical deflector 101 and the heat is uniformly conducted, a temperature deviation in the longitudinal direction and the shorter side direction has hardly occurred, and thus the description of the result for the anamorphic lens 19 is omitted.

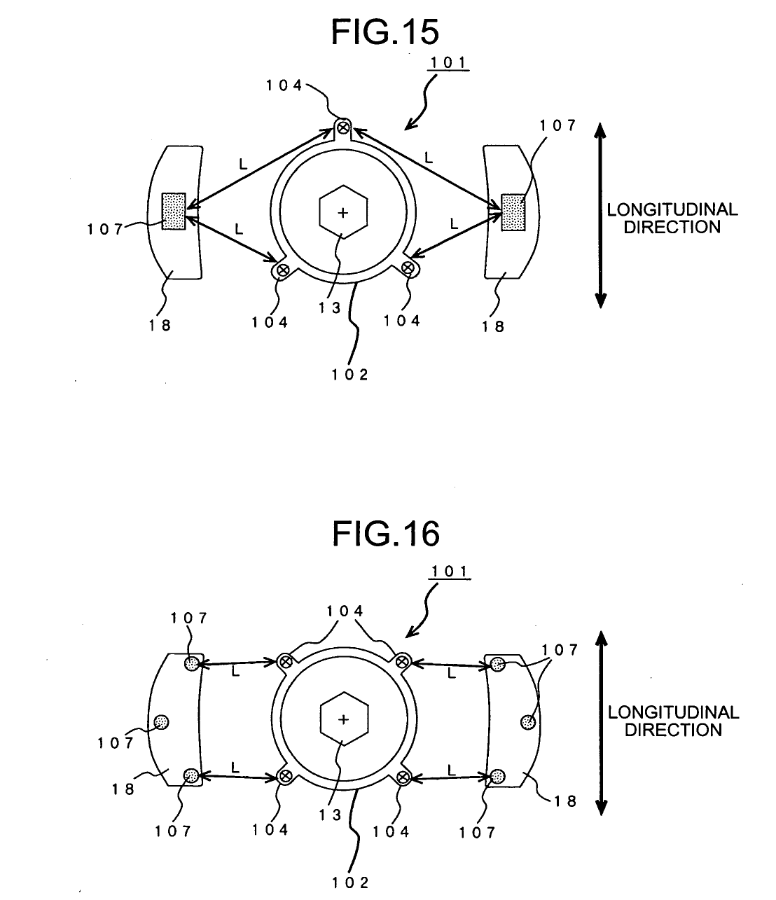

The device (1) is an optical scanning device having the same arrangement and configuration as those according to the present embodiment. The device (2) is an optical scanning device, as shown in FIG. 15, having the arrangement and configuration that the distances L from the fixing units 104 and the optical deflector positioning bases 105, which connect the optical deflector 101 to the optical housing 100, to the nearest fθ lens positioning base 107 are respectively different from each other.

In the arrangement and configuration shown in FIG. 15, since the distances L are different from each other, the heat is conducted asymmetrically from the optical deflector 101 through the optical housing 100 as the floor to the fθ lenses 18. Furthermore, since the fθ lens positioning base 107 has a certain width, the heat is conducted asymmetrically to the fθ lenses 18. Consequently, a temperature deviation occurs in the lens.

In the measurement results of the device (1) and the device (2), a temperature deviation of about two times in the longitudinal direction has occurred. In the device (1) and the device (2), the configuration is the same except of the correlation of the distances L from the fixing units 104 and the optical deflector positioning bases 105 to the nearest fθ lens positioning base 107. Accordingly, it can be recognized that the arrangement position of respective positioning bases (respective element fixing positions) is the cause of the temperature deviation, and if the distances L are substantially the same as according to the present embodiment, the temperature deviation is small.

The device (3) is an optical scanning device having an arrangement and configuration as shown in FIG. 16. The device (3) has the same configuration as that of the optical scanning device shown in FIGS. 14A and 14B, except that the fθ lens positioning base 107 for supporting the fθ lens 18 supports the lens at three points. The distances L from the fixing units 104 and the optical deflector positioning bases 105, which connect the optical deflector 101 to the optical housing 100, to the nearest fθ lens positioning base 107 are substantially the same.

The same measurement result as that of the device (1) could be obtained for the device (3). Accordingly, it can be recognized that even if there is a plurality of fθ lens positioning bases 107 for supporting the fθ lens, if the distances L from the fixing unit 104 and the optical deflector positioning bases 105 to the nearest fθ lens positioning base 107 are substantially the same, the temperature deviation occurring in the fθ lens can be suppressed.

The distance L in this context is defined only for the fθ lens positioning base 107 on the optical deflector 101 side.

In the measurement results in the devices (1) to (3), it is recognized that the inside temperature deviation in the shorter side direction of the fθ lens is larger than in the longitudinal direction of the fθ lens. This is because the heat is conducted from the optical deflector 101 to the fθ lens 18, not through the heat transmission route via the floor, but through a heat transmission route via the ambient air.

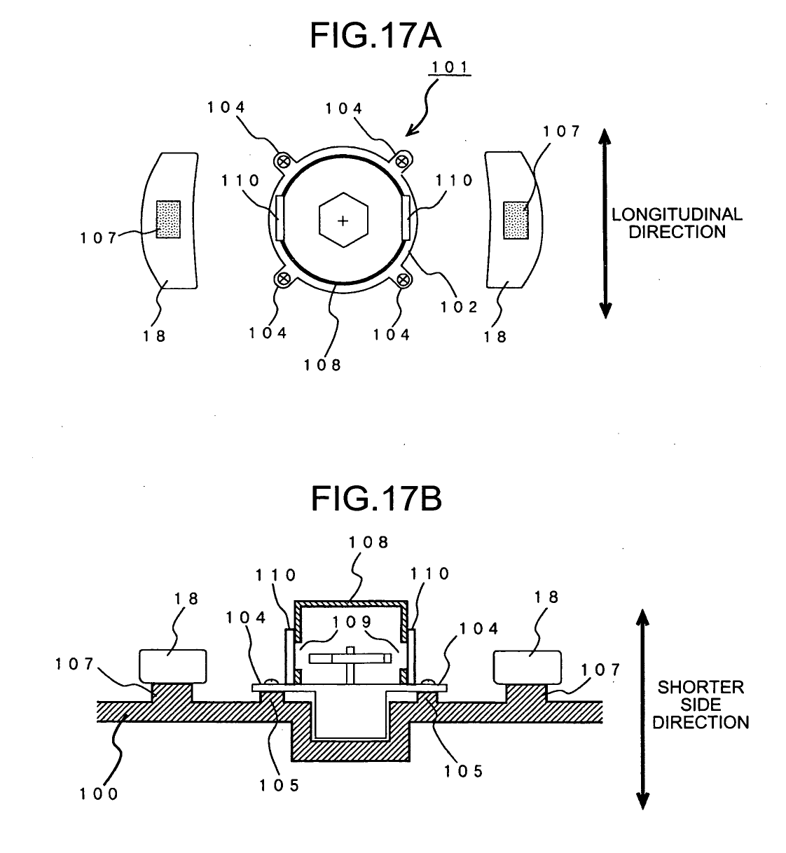

In the arrangement and configuration according to the present embodiment shown in FIGS. 14A and 14B, the heat conduction via the air is controlled by covering the optical deflector 101 with a cover 108. The optical scanning device 10 having such a configuration that the optical deflector 101 is shielded by the cover 108 is shown in FIGS. 17A and 17B.

In this configuration, the cover 108 covers the vicinity of the polygon mirror 13 on the upper surface of the optical deflector 101. An opening window 109 is respectively provided at portions through which the incident beams of light to the polygon mirror 13 and the emitted beams of light reflected and deflected by the polygon mirror 13 and directed toward the fθ lens 18 pass, and a transparent glass parallel plate 110 is adhered to the opening windows 109. The parallel plate 110 has a planar incidence plane and emission plane of beams of light.

A spatially shielded state, while being capable of transmitting the light, is formed with such a configuration, so that the heat around the polygon mirror 13 is not conducted to the fθ lens 18 via the air.

The device (4) in Table 1 is an optical scanning device having the configuration shown in FIGS. 17A and 17B. When the measurement result in the device (4) is compared with that in the device (1), it is clearly recognized that a temperature deviation in the shorter side direction is smaller in the device (4) than in the device (1). Since the only difference between these apparatuses is the presence of the cover 108, it is recognized that the effect results from the presence of the cover member.

Accordingly, by fitting the cover 108 to the optical deflector 101, heat conduction via the air can be suppressed, and the amount of temperature deviation in the shorter side direction can be suppressed, thereby achieving the optical scanning device having high accuracy.

The device (4) has a configuration in which the cover 108 is fitted to the device (1). The same effect can be expected even in a configuration in which the cover 108 is fitted to the device (3), since the device (1) and the device (3) have the same configuration except that the number of the fθ lens positioning base 107 is different, and have the same temperature deviation generation-suppressing effect to be obtained.

The device (5) is an optical scanning device having the configuration shown in FIG. 15 (the distances L are different from each other), where the cover 108, the opening window 109, and the parallel plate 110 are fitted to the optical deflector 101.

From the measurement result of the device (5), it is recognized that a temperature deviation occurring in the shorter side direction can be reduced, however, a temperature deviation occurring in the longitudinal direction increases. This is because the heat generated by the optical deflector 101 is conducted via the air and cannot be removed, and hence the amount of heat is conducted to the optical housing 100 as the floor, and then to the fθ lens 18 in a route through the floor. Since the distances L from the fixing unit 104 of the optical deflector 101 and the optical deflector positioning bases 105 to the nearest fθ lens positioning base 107 are not substantially the same, the deviation in heat conduction appears noticeable. As a result, the temperature deviation in the longitudinal direction has increased. Also from this result, the effect of arranging the distances L from the fixing unit 104 and the optical deflector positioning bases 105 to the nearest fθ lens positioning base 107 to be substantially the same can be explained.

In the optical scanning device 10 fitted with the cover 108, thermal conductivity of a material of the optical housing 100 is set lower than that of a material of the fixing unit 104 (substrate 102) adjacent to the optical housing 100, so as not to conduct the heat generated by the optical deflector 101 to the outside of the cover 108. By having such a configuration, the heat generated by the optical deflector 101 is confined within the cover 108, to reduce the amount of heat conducted to the outside of the cover member, and hence the amount of temperature deviation occurring in the fθ lens 18 can be reduced.

Furthermore, if the thermal conductivity of a material of the fθ lens 18 is set lower than that of the material of the optical housing 100, the amount of heat conducted from the optical deflector 101 to the optical housing 100 is diffused in the optical housing 100 before being conducted to the fθ lens 18. Accordingly, the amount of heat conducted to the fθ lens 18 can be reduced, thereby reducing the temperature deviation occurring in the fθ lens 18.

The device (6) has a configuration that the material of the fixing unit 104 (substrate 102) and the material of the optical housing 100 are substantially the same, in the optical scanning device of the device (5) (the distances L are different from each other, and the cover 108 is provided). In this case, since the thermal conductivity of the fixing unit 104 (substrate 102) is the same as that of the optical housing 100, it can be considered that the substrate 102 and the optical housing 100 are integrally formed in view of the thermal conductivity.

In the measurement result of the device (6), a temperature deviation in the longitudinal direction is suppressed than that in the apparatuses (1) to (5). In the case of the configuration of the device (6), heat is thoroughly radiated from the cover 108, heat conduction in the longitudinal direction of the fθ lens 18 becomes more uniform, thereby enabling suppression of an internal temperature deviation in the longitudinal direction of the lens.

When the thermal conductivity is the same, the same effect can be obtained, even if the material is different.

Also in the configuration of the device (6), if the thermal conductivity of the material of the fθ lens 18 is set lower than that of the material of the optical housing 100, the amount of heat conducted from the optical deflector 101 to the optical housing 100 is diffused in the optical housing 100 before being conducted to the fθ lens 18. Accordingly, the amount of heat conducted to the fθ lens 18 can be reduced, thereby reducing the temperature deviation occurring in the fθ lens 18.

In recent years, to achieve high density of formed images, a beam spot diameter has been reduced. Since the beam spot diameter is proportional to the wavelength of the light source, the emission wavelength of the semiconductor laser 51 needs only to be made short to achieve high density.

Conventionally, a semiconductor laser having a wavelength of 780 nanometers has been generally used. However, in the optical scanning device 10 according to the present embodiment, a semiconductor laser having a wavelength equal to or less than 500 nanometers is used as the semiconductor laser 51, to achieve high density. For example, when the wavelength is 500 nanometers, it is expressed as 500/780=⅔, and hence the beam spot diameter can be reduced to about two-thirds.

The semiconductor laser having a wavelength equal to or less than 500 nanometers is different from a semiconductor laser having a wavelength of 780 nanometers in the materials. The semiconductor laser having a wavelength of 780 nanometers is generally made of AlGaAs material, however, the semiconductor laser having a wavelength equal to or less than 500-nanometers is made of GaN material. Therefore, the semiconductor laser having a wavelength equal to or less than 500 nanometers has a larger heating value than that of the semiconductor laser having a wavelength of 780 nanometers, and it is likely to cause deterioration in a droop characteristic. Accordingly, to realize a short wavelength equal to or less than 500 nanometers as the emission wavelength of the semiconductor laser, it is necessary to reduce the heating value of the semiconductor laser.

To reduce the heating value of the semiconductor laser, only the oscillation output needs to be reduced. To achieve this, it is only necessary to form a multi-beam light source unit combined with a plurality of semiconductor lasers. In the optical scanning device 10 according to the present embodiment, since the light source unit 14 is equipped with the semiconductor lasers 51 to scan the photosensitive drum by two beams of light, the output thereof is half the output of a light source unit having only one semiconductor laser.

As the multi-beam light source unit, the light source unit 14 is formed of a plurality of semiconductor lasers 51, and if a plurality of the light source units 14 is combined, the number of beams of light for scanning the photosensitive drum 11 can be further increased. With this configuration, the output speed of the image forming apparatus can be improved. On the contrary, when the output speed is not changed, the rotation speed of the deflector can be reduced, thereby enabling formation of an environmentally-friendly writing optical system, such as reduction in power consumption and reduction in heating value.

While the semiconductor laser 51 is used as the light source according to the present embodiment, a semiconductor laser array (LDA) in which a plurality of light-emitting points is arranged in an array monolithically can be also used as the light source. The same effect can be obtained by this configuration. Furthermore, a surface emitting laser array in which a plurality of light-emitting points is arranged in an array two-dimensionally can be used as the light source, to form the multi-beam light source unit. By mounting such a multi-beam light source unit, a multi-beam optical scanning device can be formed.

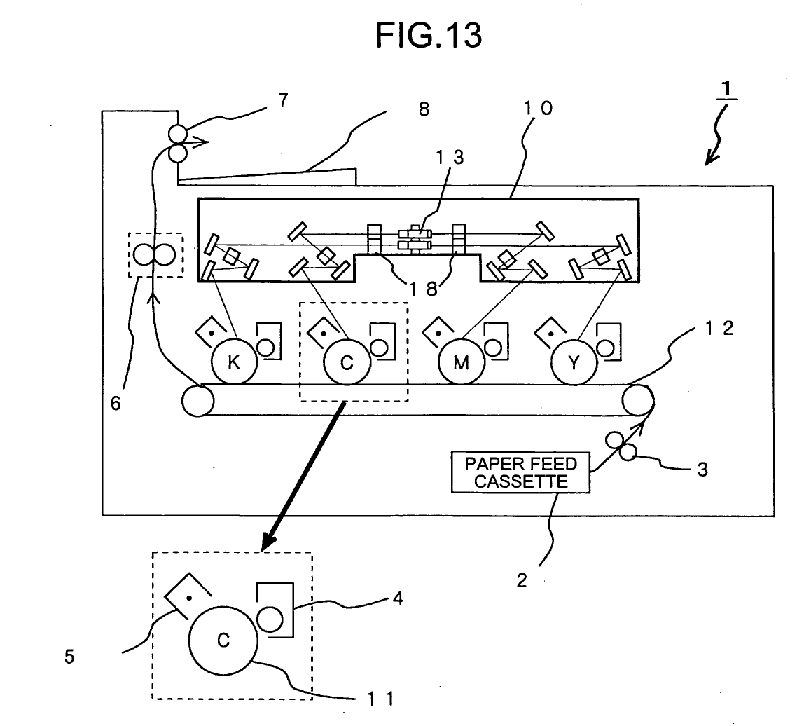

FIG. 13 is an image forming apparatus 1 of tandem type mounted with the optical scanning device 10 according to the present embodiment.

The image forming apparatus 1 includes a registration roller pair 3 that guides the recording paper fed from a paper feed cassette 2 arranged on the lower side thereof in the horizontal direction to the transfer belt 12. The transfer belt 12 (carrier belt) carries the recording paper led from the registration roller pair 3.

The photosensitive drums 11 that correspond to YMCK are provided at equal intervals on the route of the transfer belt 12. Devices that execute a process according to an electrophotographic process, that is, a developing device 4 that develops the electrostatic latent image, a charger 5 that charges the photosensitive drum 11, and the like are arranged around the photosensitive drum 11.

A write unit that writes the electrostatic latent image on the photosensitive drum 11 is formed of the optical scanning device 10 described above.

A fuser 6 that thermally fixes the toner image transferred onto the recording paper, and a paper ejection roller pair 7 for ejecting the recording paper to a paper ejection tray 8 is provided on a downstream side of the transfer belt 12.

In this schematic configuration, for example, at the time of a full color mode, optical scanning by the optical beams is performed with respect to the respective photosensitive drums 11 by the optical scanning device 10 based on respective color image signals, to form an electrostatic latent image corresponding to each color signal on the surface of the photosensitive drum 11. The electrostatic latent image is respectively developed by each color developing apparatus 4 to form a toner image. Simultaneously, the recording paper is supplied from the paper feed cassette 2. The recording paper is sent out onto the transfer belt 12 by the registration roller pair 3, coincided with the recording start timing in the vertical scanning direction.

The respective color toner images formed on the respective photosensitive drums 11 are sequentially transferred onto the recording paper carried on the transfer belt 12 and superposed on each other, thereby forming a full color image on the recording paper. The full color image is thermally fixed by the fuser 6, and ejected to the paper ejection tray 8 by the paper ejection roller pair 7.

In the image forming apparatus 1, since the optical scanning device 10 is used as the write unit, occurrence of non-uniform temperature distributions in the scanning image forming optical system, which causes the curve of scan lines and scanning misregistration, can be suppressed, thereby achieving accurate image formation. Furthermore, since an execution frequency of a series of internal correction processes can be reduced, productivity can be improved by reduction of correction during the job operation, and consumption of the toner used for the detection patterns can be also reduced.

In the configuration of the image forming apparatus 1, only one optical scanning device 10 (an integral configuration) is used, however, the optical scanning device 10 can be provided corresponding to each color, or can be provided for each of two colors (two-body configuration).

Furthermore, a network communication function can be provided, so that the image forming apparatus 1 is connected via a network with another image forming apparatus 1′, an image processor such as facsimile, and an electronic arithmetic processing unit such as a computer terminal, to form a print processing system. According to this configuration, an information processing system that can execute an output process from a plurality of equipment can be realized by one image forming apparatus. Furthermore, since the status of the respective image forming apparatuses (how many jobs are to be performed, whether the power is ON, whether there is a failure, and the like) are known from respective output requests, and an image output unit of the best condition (most suitable for user's desire) can be selected to perform the output process. As a result, the image forming apparatus can be user-friendly.

The above embodiment is one of the exemplary embodiments of the present invention, and does not limit the embodiments of the invention. Therefore, the present invention is not limited to the above embodiment, and various modifications can be made without departing from the scope of the invention.

For example, shapes and fitting methods of the respective components explained in the embodiment are not limited to those mentioned above. Therefore, while in the light source unit 14, the coupling lens 52 is fixed by the holding plate spring 55, the coupling lens 52 can be bonded and fixed by the ultraviolet hardening adhesive or the like. In addition, while the non-parallel plate holding unit 17 is used as the optical axis changing unit, a liquid crystal deflecting element or a Galvano mirror can be also used as the optical axis changing unit.

According to an embodiment of the present invention, since the heat generated by the optical deflector is symmetrically conducted to the imaging optical system, occurrence of non-uniform temperature distributions in the scanning image forming optical system, which causes the curve of scan lines and scanning misregistration, can be suppressed, thereby achieving accurate image formation. Furthermore, as additional advantages, since a frequency of executing a correction process in a print job (creation and correction of a misregistration detection pattern, re-creation of the detection pattern, and correction check) can be reduced, productivity can be improved, and consumption of the toner used in a process of correcting the deviation and power consumption can be also reduced.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical scanning device comprising:
a light source that outputs an optical beam;
an optical deflector that deflects the optical beam output from the light source;
an imaging optical system that condenses the optical beam deflected by the optical deflector onto a surface to be scanned; and
a housing that accommodates the light source, the optical deflector, and the imaging optical system, wherein
the housing includes
a plurality of optical-deflector supporting units that supports the optical deflector; and
an imaging-optical-system supporting unit that supports the imaging optical system, and
distances from each of the optical-deflector supporting units to the imaging-optical-system supporting unit are substantially the same.

2. The optical scanning device according to claim 1, wherein
the optical deflector is spatially shielded by a cover member that includes an opening window through which the optical beam passes and a transparent optical member fitted to the opening window.

3. The optical scanning device according to claim 2, wherein
the transparent optical member includes a light-flux input surface and a light-flux output surface, and
the light-flux input surface and the light-flux output surface are plane.

4. The optical scanning device according to claim 2, wherein
thermal conductivity of a material that forms the housing is lower than thermal conductivity of a material that forms a joining surface of the optical deflector for joining the optical deflector with the housing.

5. The optical scanning device according to claim 2, wherein
thermal conductivity of the material that forms the housing is higher than thermal conductivity of a material that forms the imaging optical system.

6. The optical scanning device according to claim 1, wherein
a wavelength of the optical beam output from the light source is equal to or less than 500 nanometers.

7. The optical scanning device according to claim 1, wherein
the light source is a multi-beam light source that outputs a plurality of optical beams simultaneously.

8. An optical scanning device comprising:
a light source that outputs an optical beam;
an optical deflector that deflects the optical beam output from the light source;
an imaging optical system that condenses the optical beam deflected by the optical deflector onto a surface to be scanned; and
a housing that accommodates the light source, the optical deflector, and the imaging optical system, wherein
the housing includes
a plurality of optical-deflector supporting units that supports the optical deflector; and
a plurality of imaging-optical-system supporting units that supports the imaging optical system, and
a distance from any one of the optical-deflector supporting units to a nearest optical-deflector supporting unit is substantially the same for all of the optical-deflector supporting units.

9. The optical scanning device according to claim 8, wherein
the any one of the imaging-optical-system supporting units is selected from the imaging-optical-system supporting units provided on a side close to the optical deflector.

10. The optical scanning device according to claim 8, wherein
the optical deflector is spatially shielded by a cover member that includes an opening window through which the optical beam passes and a transparent optical member fitted to the opening window.

11. The optical scanning device according to claim 10, wherein
the transparent optical member includes a light-flux input surface and a light-flux output surface, and
the light-flux input surface and the light-flux output surface are plane.

12. The optical scanning device according to claim 10, wherein
thermal conductivity of a material that forms the housing is lower than thermal conductivity of a material that forms a joining surface of the optical deflector for joining the optical deflector with the housing.

13. The optical scanning device according to claim 10, wherein
thermal conductivity of the material that forms the housing is higher than thermal conductivity of a material that forms the imaging optical system.

14. The optical scanning device according to claim 8, wherein
a wavelength of the optical beam output from the light source is equal to or less than 500 nanometers.

15. The optical scanning device according to claim 8, wherein
the light source is a multi-beam light source that outputs a plurality of optical beams simultaneously.

16. An optical scanning device comprising:
a light source that outputs an optical beam;
an optical deflector that deflects the optical beam output from the light source;
a cover member that spatially shields the optical deflector;
an imaging optical system that condenses the optical beam deflected by the optical deflector onto a surface to be scanned; and
a housing that accommodates the light source, the optical deflector, and the imaging optical system, wherein
a material that forms the housing and a material that forms a joining surface of the optical deflector for joining the optical deflector with the housing are substantially the same.

17. The optical scanning device according to claim 16, wherein
thermal conductivity of the material that forms the housing is higher than thermal conductivity of a material that forms the imaging optical system.

18. The optical scanning device according to claim 16, wherein
a wavelength of the optical beam output from the light source is equal to or less than 500 nanometers.

19. The optical scanning device according to claim 16, wherein
the light source is a multi-beam light source that outputs a plurality of optical beams simultaneously.

20. An image forming apparatus comprising:
an optical scanning device that includes
a light source that outputs an optical beam;
an optical deflector that deflects the optical beam output from the light source;
an imaging optical system that condenses the optical beam deflected by the optical deflector onto a surface to be scanned; and
a housing that accommodates the light source, the optical deflector, and the imaging optical system, wherein
the housing includes
a plurality of optical-deflector supporting units that supports the optical deflector; and
an imaging-optical-system supporting unit that supports the imaging optical system, and
distances from each of the optical-deflector supporting units to the imaging-optical-system supporting unit are substantially the same.

21. The image forming apparatus according to claim 20, wherein
the image forming apparatus is a tandem-type image forming apparatus.

22. The image forming apparatus according to claim 20, wherein
the image forming apparatus includes a network communication function.

23. An image forming apparatus comprising:
an optical scanning device that includes
a light source that outputs an optical beam;
an optical deflector that deflects the optical beam output from the light source;
an imaging optical system that condenses the optical beam deflected by the optical deflector onto a surface to be scanned; and
a housing that accommodates the light source, the optical deflector, and the imaging optical system, wherein
the housing includes
a plurality of optical-deflector supporting units that supports the optical deflector; and
a plurality of imaging-optical-system supporting units that supports the imaging optical system, and
a distance from any one of the optical-deflector supporting units to a nearest optical-deflector supporting unit is substantially the same for all of the optical-deflector supporting units.

24. The image forming apparatus according to claim 23, wherein
the image forming apparatus is a tandem-type image forming apparatus.

25. The image forming apparatus according to claim 23, wherein
the image forming apparatus includes a network communication function.

26. An image forming apparatus comprising:
an optical scanning device that includes
a light source that outputs an optical beam;
an optical deflector that deflects the optical beam output from the light source;
a cover member that spatially shields the optical deflector;
an imaging optical system that condenses the optical beam deflected by the optical deflector onto a surface to be scanned; and
a housing that accommodates the light source, the optical deflector, and the imaging optical system, wherein
a material that forms the housing and a material that forms a joining surface of the optical deflector for joining the optical deflector with the housing are substantially the same.

27. The image forming apparatus according to claim 26, wherein
the image forming apparatus is a tandem-type image forming apparatus.

28. The image forming apparatus according to claim 26, wherein
the image forming apparatus includes a network communication function.
